(19) United States
(12) Patent Application Publication
(10) Pub. No.: US 2015/0040193 A1
(43) Pub. Date: Feb. 5, 2015

(54) Physical Interaction Style Based User Authentication for Mobile Computing Devices

(71) Applicant: Datafise, LLC, Austin, TX (US)

(72) Inventor: Eric A. Clemons, Austin, TX (US)

(73) Assignee: Datafise, LLC, Austin, TX (US)

(21) Appl. No.: 13/958,280

(22) Filed: Aug. 2, 2013

(51) Int. Cl. G06F 21/31

(52) U.S. Cl. CPC G06F 21/31
USPC 726/4

(57) ABSTRACT

System and method for performing multi-factor authentication of a mobile computing device. Information identifying a mobile computing device may be received over a network, where the mobile computing device has requested access to a resource, and where the mobile computing device has a registered user. The mobile computing device may be identified based on the information identifying the mobile computing device. Information regarding a current physical interaction style with respect to the mobile computing device may be received over the network. A confidence level may be determined based on the current physical interaction style, where the confidence level indicates a degree of confidence that mobile computing device is currently being operated by the registered user of the mobile computing device. The mobile computing device may be granted access to the resource in response to the confidence level meeting or exceeding a specified threshold value.

### FIELD OF THE INVENTION

The present invention relates to the field of user authentication, and more particularly to a system and method for using multiple pattern recognition techniques a multi-factor authentication process to authenticate a user of a mobile device.

### DESCRIPTION OF THE RELATED ART

Due to the increase in the use of mobile and electronic technology in the banking industry, fraud too has increased, forcing financial institutions (FIs) to find alternative ways to protect their members. This has resulted in banks and credit unions limiting their mobile and tablet channel functionality because of the limited tools available to protect against cyber criminals. In the past, FIs have implemented various security tactics such as asking for a customer's mother's maiden name or requiring the customer to know the last four digits of the primary member's Social Security number before gaining access to account information. When using electronic channels FIs often require customers to pass a multi-factor authentication or two-factor authentication process which requires the presentation of two or more of three different authentication factors: a knowledge factor (something the user knows, i.e., password or pin (personal identification number)), a possession factor (something the user has, i.e., smart card, mobile phone), and an inherence factor (something the user is, i.e., a biometric characteristic, such as a fingerprint). Even with the above techniques, fraudsters have devised ways to intercept customer pins and passwords, steal their mobile device, impersonate customer smart phones' unique information, as well as social engineer their way to obtaining almost every public piece of information about a bank's customer necessary to access his/her account. This has forced banks and credit unions to limit functionality in mobile and tablet banking channels and to force customers to rely on non-home-banking systems to conduct higher risk transactions, such as large money wires, payroll approval, managing bill pay transactions, setup and remove alerts, etc.

Accordingly, improved systems and methods for authenticating users of financial services are needed.

### SUMMARY

Various embodiments of a system and method for physical interaction style based user authentication for mobile computing devices are presented below.

Information identifying a mobile computing device may be received over a network. The mobile computing device may have requested access to a resource, e.g., one or more of: confidential user information, confidential user account information, confidential financial information, confidential transaction information, or access information regarding a secure system, among others. Note, however, that in various other embodiments, the resource may be any type of resource as desired, the techniques disclosed herein being broadly applicable in any application domain where authentication (e.g., user authentication) is used to restrict access to a resource over a network, e.g., medical records, military information, etc. In some embodiments, the mobile computing device has a registered user. Note that a registered user may be different from a registered owner of the device. For example, a parent of a student may be the registered owner of the mobile computing device, and the student may be a registered user (possibly among other registered users of the device).

The mobile computing device may be identified based on the information identifying the mobile computing device. In other words, the method may ascertain the identity of the mobile computing device based on the received information indicating the identity of the mobile computing device. The information identifying the mobile computing device may be any of a variety of types of information, e.g., a MAC (media access control) address, a Device Unique ID, Unique Device Identification (UDI), and so forth, as desired.

Information regarding a current physical interaction style with respect to the mobile computing device may be received over the network. Said another way, information regarding the manner in which the mobile computing device is held, handled, or otherwise used or operated, may be received. For example, in one exemplary embodiment, the information regarding the current physical interaction style may include an angle at which the mobile computing device is positioned during operation. In another embodiment, the information regarding a current physical interaction style may include coordinates at which fingers of a current user of the mobile computing device consistently contact a touch screen or touch pad of the mobile computing device, data entry/typing rate or variability in the rate. In another exemplary embodiment, the information regarding a current physical interaction style may include information regarding input gestures used by a current user when interacting with the mobile computing device via a touch screen or touch pad. In a further embodiment, the information regarding a current physical interaction style may include information indicating whether a current user uses two-hands or one-hand when interacting with the mobile computing device, e.g., based on screen or touchpad inputs.

Note that in some embodiments, the information regarding the current physical interaction style with respect to the mobile computing device may indicate that there is no human user currently operating the device. For example, the information regarding a current physical interaction style may include information indicating no movement of the mobile computing device over a specified time period, where no movement indicates that there is no human user currently operating the mobile computing device. Thus, for example, in an exemplary case where a malicious program (or malware) has usurped control of the device, the malicious program may fraudulently pose as the registered user, but may not be capable of faking dynamic position or movement signals from the device, and so the method may detect (or at least suspect) such fraudulent activity via a lack of movement of the device.

A confidence level may be determined (e.g., computed, looked-up, etc.) based (at least) on the current physical interaction style, where the confidence level indicates a degree of confidence that the mobile computing device is currently being operated by the registered user of the mobile computing device. Note that the relationship or mapping between the determined confidence level and the degree of confidence that the mobile computing device is currently being operated by the registered user of the mobile computing device may be determined via any of a variety of ways. For example, in one embodiment, statistical data may be collected via laboratory testing and/or real world monitoring, where various interaction styles may be recorded and compared to corresponding user identities (be they human or software), and characteristic user interaction profiles determined and stored. Similarly, in some embodiments, the physical interaction style of the registered user(s) of the device may be monitored and that user's personal physical interaction style (or styles) may be determined or characterized and stored for use by the method.

In one embodiment, determining the confidence level may include computing a risk score based (at least) on the current physical interaction style, and determining the confidence level based on the risk score. It should be noted that the terms “confidence level” and “risk score” are meant to be descriptive only, and that any other terms for such notions may be used as desired.

The mobile computing device may be granted access to the resource in response to the confidence level meeting or exceeding a specified threshold value. In other words, the method may determine that the current user is likely the registered user, and may accordingly grant the mobile computing device access to the resource. In one embodiment, granting the mobile computing device access to the resource in response to the confidence level meeting or exceeding a specified threshold value may include authenticating a current user of the mobile computing device as the registered user in response to the confidence level meeting or exceeding a specified threshold value, and granting the mobile computing device access to the resource in response to the authenticating.

Alternatively, in response to the confidence level failing to meet or exceed the specified threshold value, the method may include initiating communication with the registered user via another network, and determining whether the mobile computing device is currently being operated by the registered user based on a response from the registered user. In response to determining that the mobile computing device is currently being operated by the registered user, the mobile computing device may be granted access to the resource. In other words, if the confidence level is not high enough to indicate that the device is currently being operated by the registered user, the method may contact the registered user via a different network than that by which the device is communicating with the computer system to confirm (or refute) that the current user is in fact the registered user.

In a further embodiment, in response to the confidence level failing to meet or exceed the specified threshold value, the method may include initiating communication with the current user via the mobile computing device (over the currently used network). For example, the method may include initiating voice communication with the mobile computing device (e.g., placing a telephone call, initiating some other type of voice communication session, activating a receiver, etc.) to the mobile computing device, and prompting the current user to speak, e.g., to verbally confirm a (previously) specified authentication phrase. In response to receiving or capturing vocal audio signals (speech) from the current user via the mobile computing device, e.g., the transmitted authentication phrase spoken by the current user, the vocal audio signals (e.g., the spoken authentication phrase) may be analyzed, e.g., via pattern recognition, e.g., voice recognition, voice analysis, etc. For example, in one embodiment, the received/captured authentication phrase may be compared to a previously stored authentication phrase set up (e.g., recorded) by the registered user. If the analysis indicates that the current user is the registered user, then access to the resource may be granted to the mobile computing device (or user via the device). If the analysis indicates that the current user is not the registered user, then access to the resource may be withheld or retracted.

In one embodiment, if the registered user has not setup an authentication phrase, a text message or email may be sent to the user (or a telephone call or other voice communication initiated) via a second (or different/other, i.e., out of band, meaning other than the currently used network) communication network using a previously stored number or email address associated with the mobile computing device, similar to above.

Thus, a physical interaction style regarding the mobile computing device may provide an additional reliable security metric regarding the granting of access to a resource above and beyond standard multi-factor authentication techniques.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an exemplary system comprising a mobile computing device coupled to a computer system over a network, where the system is configured to implement embodiments of the present invention;

FIG. 2 is an exemplary block diagram of the computer system of FIG. 1, according to one embodiment;

FIG. 3 is an exemplary block diagram of the mobile computing device of FIG. 1, according to one embodiment; and

FIG. 4 is a flowchart diagram illustrating one embodiment of a method for authenticating a user of a mobile device.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning. The term “program” includes 1) a software program which may be stored in a memory and is executable by a processor or 2) a hardware configuration program useable for configuring a programmable hardware element.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Functional Unit (or Processing Element)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

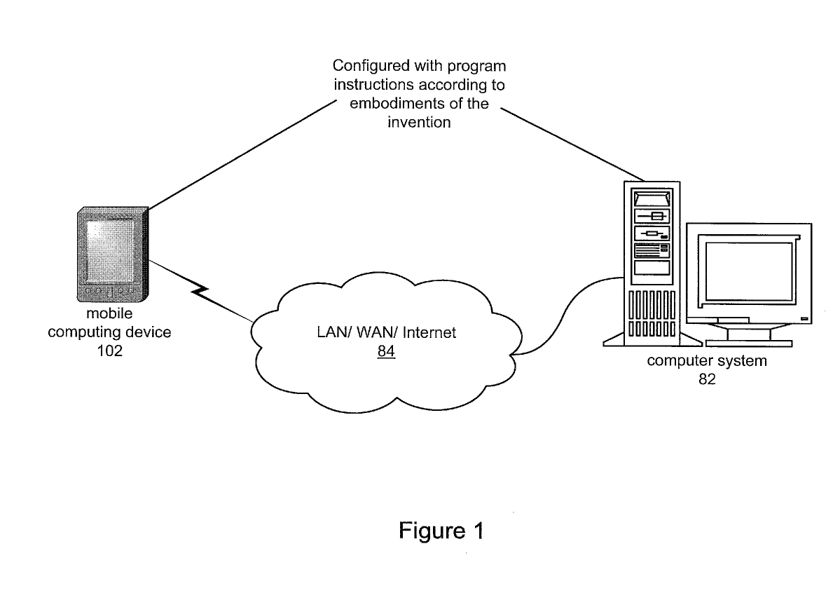

### FIG. 1—Exemplary System

FIG. 1 illustrates an exemplary system comprising a mobile computing device 102 coupled to a computer system 82 over a network by wireless means, where the system is configured to implement embodiments of the techniques disclosed herein. Embodiments of a method for authenticating a user of a mobile device are described below.

As shown in FIG. 1, the computer system 82 may include a display device configured to display a graphical user interface (GUI) of a program implementing embodiments of the present techniques. For example, in some embodiments, the display device may be configured to display the GUI of the program during execution of the program. The graphical user interface may comprise any type of graphical user interface, e.g., depending on the computing platform. In some embodiments, the computer system may be “headless”, i.e., may lack a display device. For example, the computer system may be an embedded computer system, or may be a server in a server farm, where operator interactions are performed over a network, e.g., via a browser executing on another computer system.

The computer system 82 may include at least one memory medium on which one or more computer programs or software components according to one embodiment of the present invention may be stored. For example, the memory medium may store one or more programs which are executable to perform the methods described herein. The memory medium may also store operating system software, as well as other software for operation of the computer system. Various embodiments further include receiving or storing instructions and/or data implemented in accordance with the foregoing description upon a carrier medium.

The computer system 82 may be included as part of a financial system, e.g., a bank, stock brokerage, etc., or may belong to a third party that provides security or authentication services for such systems.

The mobile computing device 102 may also include a processor and memory. The memory of the mobile computing device 102 may also store program instructions (e.g., one or more programs) implementing embodiments of the present techniques. Moreover, in some embodiments, the mobile computing device 102 and the computer system 82 may operate in conjunction to implement embodiments of the techniques disclosed herein. The mobile computing device 102 may be any type of mobile computing device desired, e.g., a smart-phone, a feature-phone, a tablet computer, a “phablet”, a laptop computer, a smart watch or any other type of wearable computing device, and so forth, as desired.

The network 84 can also be any of various types, including a LAN (local area network), WAN (wide area network), the Internet, or an Intranet, among others. The computer system 82 and mobile computing device may execute one or more programs in a distributed fashion. For example, computer 82 may execute a first portion of the program(s) and mobile computing device 102 may execute a second portion of the program(s).

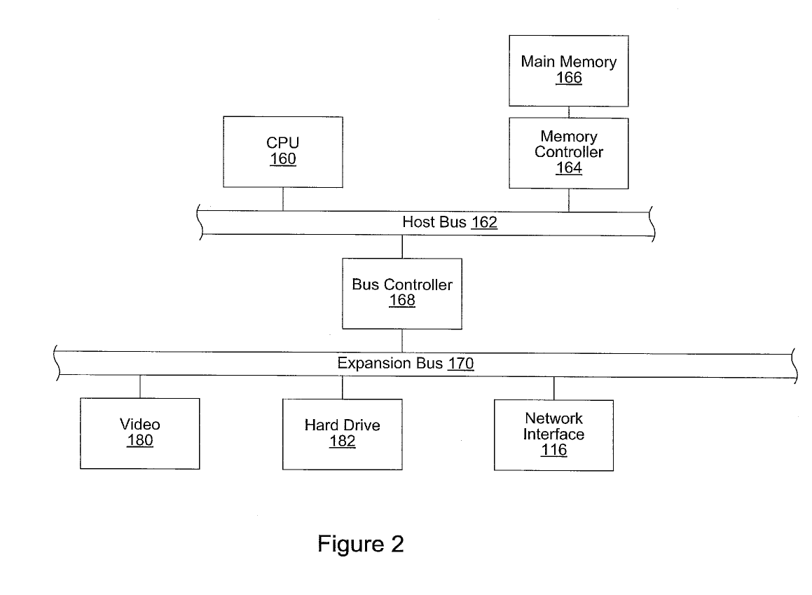

### FIG. 2—Computer System Block Diagram

FIG. 2 is a block diagram representing one embodiment of the computer system 82 illustrated in FIG. 1. It is noted that any type of computer system configuration or architecture can be used as desired, and FIG. 2 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, an Intel Core™ processor, a PowerPC™ processor, a CPU from the SPARC™ family of RISC processors, as well as others. A memory medium, typically comprising RAM and referred to as main memory, 166 is coupled to the host bus 162 by means of memory controller 164. The main memory 166 may store one or more programs implementing at least part of the techniques disclosed herein. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer system 82 may further include a video display subsystem 180 and hard drive 182 coupled to the expansion bus 170. The computer 82 may also include a network interface 116 for communicating over a network, e.g., a wide area network (WAN), such as the Internet, a local area network (LAN), or a cellular network, among others.

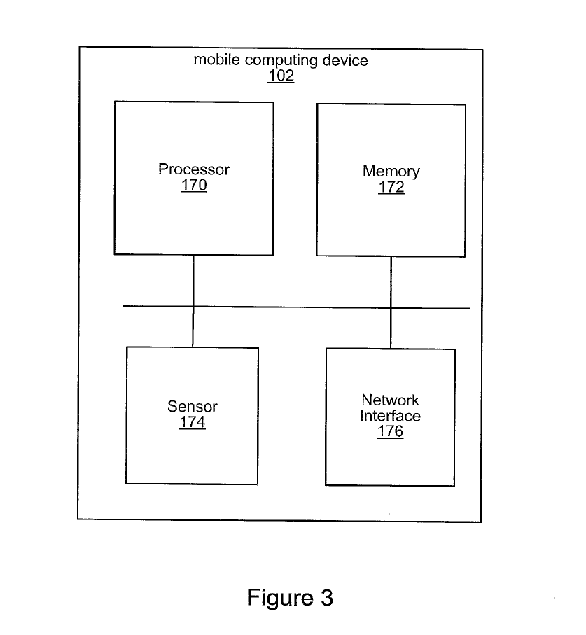

### FIG. 3—Mobile Computing Device Block Diagram

FIG. 3 is a block diagram representing one embodiment of the mobile computing device illustrated in FIG. 1. It is noted that any type of mobile computer system configuration or architecture can be used as desired, and FIG. 3 illustrates one representative embodiment. As noted above, the mobile computing device system may be any type of mobile computing device as desired, e.g., a smart-phone, a feature-phone, a tablet computer, a “phablet”, a laptop computer, a smart watch or other wearable computing device, and so forth, as desired. Elements of the device not necessary to understand the present description have been omitted for simplicity.

As shown, in this exemplary embodiment, the mobile computing device 102 may include a processor 170 (or more generally, a functional unit or processing element), which may be any type of processor as desired, e.g., an ARM processor, an Intel processor, etc. However, in other embodiments, the processor may be implemented in programmable hardware, e.g., on a field programmable gate array (FPGA), or may be an application specific integrated circuit (ASIC). The mobile computing device 102 may also include a memory 172 coupled to the processor 170, as well as a network interface 176 for communications over a network, e.g., a wireless network adaptor. The memory may be any type of memory desired, e.g., RAM, Flash memory, microdrive, ROM, firmware, etc. The memory 172 may store program instructions implementing at least a portion of the techniques disclosed herein, as well as one or more programs implementing other functions of the device.

In the exemplary embodiment shown, the device may further include a sensor, e.g., an orientation or motion sensor, e.g., a gyroscope and/or an accelerometer, whereby position and/or movement of the device may be detected, as discussed below in more detail. It should be noted that the components shown in FIG. 3 are exemplary only, and that other components, including other sensors, may be included as desired.

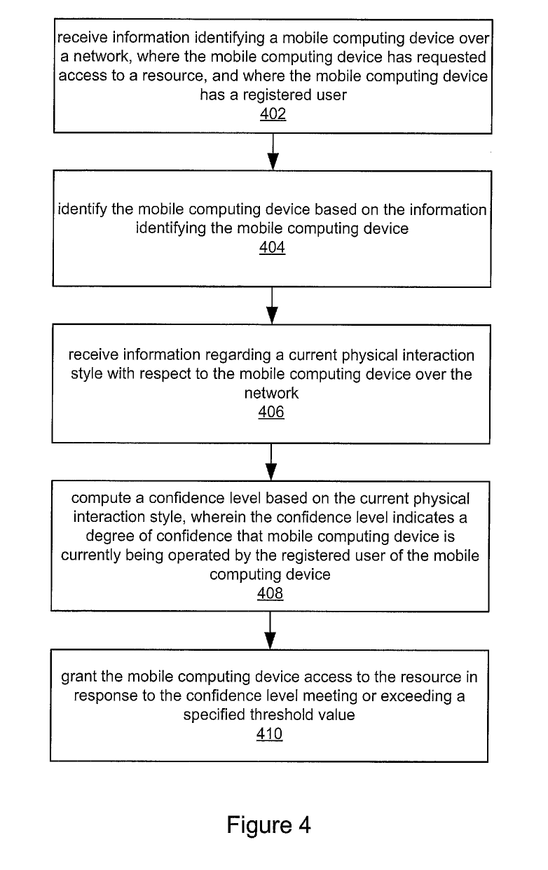

### FIG. 4—Flowchart of a Method for Authenticating a User of a Mobile Computing Device

FIG. 4 illustrates a method for using multiple pattern recognition techniques a multi-factor authentication process to authenticate a user of a mobile computing device, which may be referred to herein as the “mobile device” or simply the “device”. The method shown in FIG. 4 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 402, information identifying a mobile computing device may be received over a network. The mobile computing device may have requested access to a resource, e.g., one or more of: confidential user information, confidential user account information, confidential financial information, confidential transaction information, or access information regarding a secure system, among others. Note, however, that in various other embodiments, the resource may be any type of resource as desired, the techniques disclosed herein being broadly applicable in any application domain where user authentication is used to restrict access to a resource over a network, e.g., medical records, military information, etc. In some embodiments, the mobile computing device has a registered user. Note that a registered user may be different from a registered owner of the device. For example, a parent of a student may be the registered owner of the mobile computing device, and the student may be a registered user (possibly among other registered users of the device).

In 404, the mobile computing device may be identified based on the information identifying the mobile computing device. In other words, the method may ascertain the identity of the mobile computing device based on the received information indicating the identity of the mobile computing device. The information identifying the mobile computing device may be any of a variety of types of information, e.g., a MAC (media access control) address, a Device Unique ID, Unique Device Identification (UDI), and so forth, as desired.

In 406, information regarding a current physical interaction style with respect to the mobile computing device may be received over the network. Said another way, information regarding the manner in which the mobile computing device is held, handled, or otherwise used, may be received. For example, in one exemplary embodiment, the information regarding the current physical interaction style may include an angle at which the mobile computing device is positioned during operation. In another embodiment, the information regarding a current physical interaction style may include coordinates at which fingers of a current user of the mobile computing device consistently contact a touch screen or touch pad of the mobile computing device, data entry/typing rate or variability in the rate. In another exemplary embodiment, the information regarding a current physical interaction style may include information regarding input gestures used by a current user when interacting with the mobile computing device via a touch screen or touch pad. In a further embodiment, the information regarding a current physical interaction style may include information indicating whether a current user uses two-hands or one-hand when interacting with the mobile computing device, e.g., based on screen or touchpad inputs.

Note that in some embodiments, the information regarding the current physical interaction style with respect to the mobile computing device may indicate that there is no human user currently operating the device. For example, the information regarding a current physical interaction style may include information indicating no movement of the mobile computing device over a specified time period, where no movement indicates that there is no human user currently operating the mobile computing device. Thus, for example, in an exemplary case where a malicious program (or malware) has usurped control of the device, the malicious program may fraudulently pose as the registered user, but may not be capable of faking dynamic position or movement signals from the device, and so the method may detect (or at least suspect) such fraudulent activity via a lack of movement of the device.

In 408, a confidence level may be determined (e.g., computed, looked-up, etc.) based (at least) on the current physical interaction style, where the confidence level indicates a degree of confidence that the mobile computing device is currently being operated by the registered user of the mobile computing device. Note that the relationship or mapping between the determined confidence level and the degree of confidence that the mobile computing device is currently being operated by the registered user of the mobile computing device may be determined via any of a variety of ways. For example, in one embodiment, statistical data may be collected via laboratory testing and/or real world monitoring, where various interaction styles may be recorded and compared to corresponding user identities (be they human or software), and characteristic user interaction profiles determined and stored. Similarly, in some embodiments, the physical interaction style of the registered user(s) of the device may be monitored and that user's personal physical interaction style (or styles) may be determined or characterized and stored for use by the method.

In one embodiment, determining the confidence level may include computing a risk score based (at least) on the current physical interaction style, and determining the confidence level based on the risk score. It should be noted that the terms “confidence level” and “risk score” are meant to be descriptive only, and that any other terms for such notions may be used as desired.

In 410, the mobile computing device may be granted access to the resource in response to the confidence level meeting or exceeding a specified threshold value. In other words, the method may determine that the current user is likely the registered user, and may accordingly grant the mobile computing device access to the resource. In one embodiment, granting the mobile computing device access to the resource in response to the confidence level meeting or exceeding a specified threshold value may include authenticating a current user of the mobile computing device as the registered user in response to the confidence level meeting or exceeding a specified threshold value, and granting the mobile computing device access to the resource in response to the authenticating.

Alternatively, in response to the confidence level failing to meet or exceed the specified threshold value, the method may include initiating communication with the registered user via another network (e.g., “out of band”), and determining whether the mobile computing device is currently being operated by the registered user based on a response from the registered user. In response to determining that the mobile computing device is currently being operated by the registered user, the mobile computing device may be granted access to the resource. In other words, if the confidence level is not high enough to indicate that the device is currently being operated by the registered user, the method may contact the registered user via a different network than that by which the device is communicating with the computer system to confirm (or refute) that the current user is in fact the registered user.

In a further embodiment, in response to the confidence level failing to meet or exceed the specified threshold value, the method may include initiating communication with the current user via the mobile computing device (over the currently used network). For example, the method may include initiating voice communication with the mobile computing device (e.g., placing a telephone call, initiating some other type of voice communication session, activating a receiver, etc.) to the mobile computing device, and prompting the current user to speak, e.g., to verbally confirm a (previously) specified authentication phrase. In response to receiving or capturing vocal audio signals (speech) from the current user via the mobile computing device, e.g., the transmitted authentication phrase spoken by the current user, the vocal audio signals (e.g., the spoken authentication phrase) may be analyzed, e.g., via pattern recognition, e.g., voice recognition, voice analysis, etc. For example, in one embodiment, the received/captured authentication phrase may be compared to a previously stored authentication phrase set up (e.g., recorded) by the registered user. If the analysis indicates that the current user is the registered user, then access to the resource may be granted to the mobile computing device (or user via the device). If the analysis indicates that the current user is not the registered user, then access to the resource may be withheld or retracted.

In one embodiment, if the registered user has not setup an authentication phrase, a text message or email may be sent to the user via a second (or different/other, i.e., out of band, meaning other than the currently used network) communication network using a previously stored number or email address associated with the mobile computing device, similar to above.

### Exemplary Embodiments

The following presents various exemplary embodiments of the techniques disclosed above, although it should be noted that the embodiments described are exemplary only, and are not intended to limit the techniques or systems to any particular form, function, or appearance. Moreover, any of the features disclosed herein may be used in any combination desired.

In one embodiment, receiving information regarding the current physical interaction style and said determining the confidence level may include repeating the receiving information regarding the physical interaction style (406) and the determining the confidence level (408) one or more times in an iterative manner. Granting the mobile computing device access to the resource in response to the confidence level meeting or exceeding the specified threshold value (410) may be performed in response to the confidence level meeting or exceeding the specified threshold value at any point during the repeating. In other words, the physical interaction style may be monitored periodically or even (effectively) continually, and as soon as the confidence level meets or exceeds the threshold, access to the resource may be granted to the device.

Similarly, in some embodiment, after granting the mobile computing device access to the resource, the receiving information regarding the current physical interaction style (406) may be repeated one or more times in an iterative manner, and the current physical interaction style compared to previous physical interaction styles associated with the mobile computing device, thereby characterizing the current physical interaction style. The previous physical interaction styles may then be updated in accordance with the current physical interaction style in response to granting the mobile computing device access to the resource. Thus, once the method determines that the current user is (likely to be) the registered user of the device, the stored previous physical interaction styles may be modified to reflect the current physical interaction style.

Similarly, in some embodiments, after granting the mobile computing device access to the resource, the receiving information regarding the current physical interaction style and determining the confidence level, may be repeated one or more times in an iterative manner, and if the confidence level ever fails to meet or exceed the specified threshold value during said repeating, the mobile computing device's access to the resource may be retracted. Moreover, if the confidence level ever fails to meet or exceed the specified threshold value during said repeating, communication with the registered user may be initiated via another network, and in response to said communicating with the registered user, the method may determine whether a current user of the mobile computing device is the registered user. If the current user is determined to be the registered user, the method may re-grant the mobile computing device access to the resource. Thus, access to the resource may be granted or retracted dynamically during operation of the device.

As noted above, the current physical interaction style may be determined via any of a variety of ways. In one embodiment, the mobile computing device may include an orientation sensor, e.g., a gyroscope and/or an accelerometer, and at least some of the information regarding the current physical interaction style may be generated using the orientation sensor of the mobile computing device. Additionally, or alternatively, the current physical interaction style may be determined by monitoring user input to the device, e.g., data entry rates, e.g., typing speed and/or variations in such, as indicated above.

In one embodiment, communicating with the registered user via another network may include placing a telephone call to the registered user (or initiating some other type of voice communication with the registered user), or sending a text message to the registered user, e.g., email, instant messaging, posting to a social network page, paging, although any other network means may be used as desired. Communicating with the registered user via another network may be performed based on previously stored contact information associated with the mobile computing device.

In some embodiments, the method may further include receiving the registered user's password or personal identification number (PIN) over the network, and determining a rate at which the password or PIN was entered to the mobile computing device. Determining a confidence level may accordingly be further based on the rate at which the user's password or PIN was entered.

The method may also include receiving information regarding current location of the mobile computing device over the network, and determining whether the current location is a location from which the mobile computing device has previously accessed the resource based on one or more previous locations from which the mobile computing device accessed the resource. If the current location is not a location from which the mobile computing device has previously accessed the resource, the method may determine the probability that the registered user is at the current location, and may determine the confidence level further based on the probability that the registered user is at the current location. Similar to the determination of the confidence level regarding user's identity, the determination of the probability that the registered user is at the current location may be based on statistical analysis of the registered user's previous locations when using the device.

In one particular exemplary embodiment or use case, the above method of granting access to a resource by a mobile computing device, e.g., authenticating a mobile computing device (or the user of the device) for accessing the resource, may be considered as using a series of pattern recognition techniques, e.g., various aspects of the physical interaction style regarding the mobile computing device, coupled with the traditional multi-factor authentication methods. These techniques may include one or more of: 1) identifying the user's device (is this a device the customer have successfully used in the past?); 2) receiving user input of a known pin/password; 3) verifying the current location of where the customer is while trying to access the resource, where if the current location is not one from which the user has accessed the resource in the past, the method may determine the likelihood that the registered user could be at the current location, based on the previous locations from which the user accessed the resource (e.g., geographic region, location of last known transactions, etc.); 4) determining the rate of speed at which the user types or enters their pin/password; 5) for mobile and tablet devices, utilizing accelerometer or gyroscope metrics (e.g., angle at which the device is held, movement, etc.), coordinates at which the customer's fingers consistently contact the screen, whether the customer utilizes two-hands or one-hand, and so forth, to determine the current user's physical interaction style with the device; and/or 6) continuously using accelerometer or gyroscope metrics after granting access or authentication to compare current interaction methods to the patterns of previous interaction methods. A computed risk score may be constantly recalculated in real-time to determine the confidence level of the method or system that the current user attempting to access the resource is the registered user (customer) who owns the resource (or the resource's data).

If at any point the confidence level is above the risk tolerance of the institution, a second factor authentication may be skipped and the user/customer may be granted full access to the resource. In the event that the risk score is below the acceptable confidence level of the institution the method or system may initiate the second factor authentication step, e.g., placing a telephone call (or otherwise initiating voice communication with the mobile computing device) or sending a text message to the user across a second communication network using a previously stored number associated with the customer's device being used.

Thus, a physical interaction style regarding the mobile computing device may provide an additional reliable security metric regarding the granting of access to a resource above and beyond standard multi-factor authentication techniques.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A non-transitory computer accessible memory medium that stores program instructions executable by a processor to perform:
receiving information identifying a mobile computing device over a network, wherein the mobile computing device has requested access to a resource, and wherein the mobile computing device has a registered user;
identifying the mobile computing device based on the information identifying the mobile computing device;
receiving information regarding a current physical interaction style with respect to the mobile computing device over the network;
determining a confidence level based on the current physical interaction style, wherein the confidence level indicates a degree of confidence that mobile computing device is currently being operated by the registered user of the mobile computing device;
granting the mobile computing device access to the resource in response to the confidence level meeting or exceeding a specified threshold value.

2. The non-transitory computer accessible memory medium of claim 1, wherein the program instructions are further executable to perform:
in response to the confidence level failing to meet or exceed the specified threshold value:
initiating communication with the registered user via another network;
determining whether the mobile computing device is currently being operated by the registered user based on a response from the registered user; and
granting the mobile computing device access to the resource in response to determining that the mobile computing device is currently being operated by the registered user.

3. The non-transitory computer accessible memory medium of claim 2, wherein said initiating communication with the registered user via another network comprises:
placing a telephone call to the registered user; or
sending a text message to the registered user.

4. The non-transitory computer accessible memory medium of claim 1,
wherein said receiving information regarding the current physical interaction style and said determining the confidence level comprises:
repeating said receiving information regarding the physical interaction style and said determining the confidence level one or more times in an iterative manner; and
wherein said granting the mobile computing device access to the resource in response to the confidence level meeting or exceeding the specified threshold value is performed in response to the confidence level meeting or exceeding the specified threshold value at any point during said repeating.

5. The non-transitory computer accessible memory medium of claim 1, wherein the program instructions are further executable to perform:
after said granting the mobile computing device access to the resource, repeating said receiving information regarding the current physical interaction style one or more times in an iterative manner; and
comparing the current physical interaction style to previous physical interaction styles associated with the mobile computing device, thereby characterizing the current physical interaction style.

6. The non-transitory computer accessible memory medium of claim 5, wherein the program instructions are further executable to perform:
updating the previous physical interaction styles in accordance with the current physical interaction style in response to granting the mobile computing device access to the resource.

7. The non-transitory computer accessible memory medium of claim 1, wherein the mobile computing device comprises an orientation sensor, and wherein at least some of the information regarding the current physical interaction style is generated using the orientation sensor of the mobile computing device.

8. The non-transitory computer accessible memory medium of claim 1, wherein the information regarding the current physical interaction style comprises:
angle at which the mobile computing device is positioned during operation.

9. The non-transitory computer accessible memory medium of claim 1, wherein the information regarding a current physical interaction style comprises:
coordinates at which fingers of a current user of the mobile computing device consistently contact a touch screen or touch pad of the mobile computing device.

10. The non-transitory computer accessible memory medium of claim 1, wherein the information regarding a current physical interaction style comprises:
information regarding input gestures used by a current user when interacting with the mobile computing device via a touch screen or touch pad.

11. The non-transitory computer accessible memory medium of claim 1, wherein the information regarding a current physical interaction style comprises:
information indicating whether a current user uses two-hands or one-hand when interacting with the mobile computing device.

12. The non-transitory computer accessible memory medium of claim 1, wherein the information regarding a current physical interaction style comprises:
information indicating no movement of the mobile computing device over a specified time period, wherein no movement indicates that there is no current human user of the mobile computing device.

13. The non-transitory computer accessible memory medium of claim 1, wherein said determining the confidence level comprises:
computing a risk score based on:
the current physical interaction style; and
determining the confidence level based on the risk score.

14. The non-transitory computer accessible memory medium of claim 1, wherein said granting the mobile computing device access to the resource in response to the confidence level meeting or exceeding a specified threshold value comprises:
authenticating a current user of the mobile computing device as the registered user in response to the confidence level meeting or exceeding a specified threshold value; and
granting the mobile computing device access to the resource in response to said authenticating.

15. The non-transitory computer accessible memory medium of claim 1, wherein said communicating with the registered user via another network is performed based on previously stored contact information associated with the mobile computing device.

16. The non-transitory computer accessible memory medium of claim 1, wherein the program instructions are further executable to perform:
receiving the registered user's password or personal identification number (PIN) over the network; and
determining a rate at which the password or PIN was entered to the mobile computing device;
wherein said determining a confidence level is further based on:
the rate at which the user's password or PIN was entered.

17. The non-transitory computer accessible memory medium of claim 1, wherein the program instructions are further executable to perform:
receiving information regarding current location of the mobile computing device over the network;
determining whether the current location is a location from which the mobile computing device has previously accessed the resource based on one or more previous locations from which the mobile computing device accessed the resource;
if the current location is not a location from which the mobile computing device has previously accessed the resource:
determining the probability that the registered user is at the current location; and
determining the confidence level further based on:
the probability that the registered user is at the current location.

18. The non-transitory computer accessible memory medium of claim 1, wherein the program instructions are further executable to perform:
after said granting the mobile computing device access to the resource, repeating said receiving information regarding the current physical interaction style and said determining the confidence level, one or more times in an iterative manner; and
if the confidence level ever fails to meet or exceed the specified threshold value during said repeating, retracting the mobile computing device's access to the resource.

19. The non-transitory computer accessible memory medium of claim 18, wherein the program instructions are further executable to perform:
if the confidence level ever fails to meet or exceed the specified threshold value during said repeating, initiating communication with the registered user via another network;
in response to said communicating with the registered user, determining whether a current user of the mobile computing device is the registered user; and
re-granting the mobile computing device access to the resource if the current user is determined to be the registered user.

20. The non-transitory computer accessible memory medium of claim 1, wherein the resource comprises one or more of:
confidential user information;
confidential user account information;
confidential financial information;
confidential transaction information; or
access information regarding a secure system.

21. The non-transitory computer accessible memory medium of claim 1, wherein the program instructions are further executable to perform:
in response to the confidence level failing to meet or exceed the specified threshold value:
initiating voice communication with the mobile computing device over the network;
prompting the current user to speak a specified authentication phrase;
receiving and analyzing a spoken authentication phrase from the mobile computing device over the network;
determining whether the mobile computing device is currently being operated by the registered user based on said analyzing the spoken authentication phrase; and
granting the mobile computing device access to the resource in response to determining that the mobile computing device is currently being operated by the registered user; or
withholding or retracting access to the resource in response to determining that the mobile computing device is not currently being operated by the registered user.

22. A system, comprising:
a processor; and
a memory, coupled to the processor, wherein the memory stores program instructions executable by the processor to:
receive information identifying a mobile computing device over a network, wherein the mobile computing device has requested access to a resource, and wherein the mobile computing device has a registered user;
identify the mobile computing device based on the information identifying the mobile computing device;
receive information regarding a current physical interaction style with respect to the mobile computing device over the network;
determine a confidence level based on the current physical interaction style, wherein the confidence level indicates a degree of confidence that mobile computing device is currently being operated by the registered user of the mobile computing device;
grant the mobile computing device access to the resource in response to the confidence level meeting or exceeding a specified threshold value.

23. A computer implemented method, comprising:
utilizing a computer to perform:
receiving information identifying a mobile computing device over a network, wherein the mobile computing device has requested access to a resource, and wherein the mobile computing device has a registered user;
identifying the mobile computing device based on the information identifying the mobile computing device;
receiving information regarding a current physical interaction style with respect to the mobile computing device over the network;
determining a confidence level based on the current physical interaction style, wherein the confidence level indicates a degree of confidence that mobile computing device is currently being operated by the registered user of the mobile computing device; and
granting the mobile computing device access to the resource in response to the confidence level meeting or exceeding a specified threshold value; or
denying the mobile computing device access to the resource in response to the confidence level failing to meet or exceed the specified threshold value.
